(19) United States
(12) Patent Application Publication
(10) Pub. No.: US 2016/0314505 A1
(43) Pub. Date: Oct. 27, 2016

(54) CROWD SOURCED ESTIMATION SYSTEM

(71) Applicants: Todd Miller, Las Vegas, NV (US); Kristian Peter, Chula Vista, CA (US)

(72) Inventors: Todd Miller, Las Vegas, NV (US); Kristian Peter, Chula Vista, CA (US)

(21) Appl. No.: 14/694,943

(22) Filed: Apr. 23, 2015

(51) Int. Cl. G06Q 30/02; G06Q 50/16

(52) U.S. Cl. CPC G06Q 30/0278; G06Q 30/0283; G06Q 50/16

(57) ABSTRACT

A crowd sourced estimation system provides crowd sourced estimates from one or more estimators that are selected based on one or more predefined criteria. In operation, a user may request and estimate for a property identified by a property identifier. The estimation system may then transmit estimate requests to the selected estimators and generate an aggregate estimate from the estimates received from the estimators as a result. The aggregate estimate is then communicated to the user. The predefined criteria may include location or distance from the property for which an estimate is to be generated.

### BACKGROUND OF THE INVENTION

1. Field of the Invention

The invention relates to property value estimates and in particular to a crowd sourced estimation system for property.

2. Related Art

When selling their property it is desirable for a seller to have an accurate concept of the property's value. A seller may then seek a higher or lower price or the same or similar price as the estimate at their discretion. However, sellers may not necessarily be in a position or have the experience or expertise to accurately value their property, especially for specialized properties.

From the discussion that follows, it will become apparent that the present invention addresses the deficiencies associated with the prior art while providing numerous additional advantages and benefits not contemplated or possible with prior art constructions.

### SUMMARY OF THE INVENTION

A crowd sourced estimation system is disclosed herein. As will be disclosed herein, the estimation system generates aggregate estimates based on estimates from individual estimators. The estimators may be selected based on predefined criteria to help ensure estimate accuracy.

Various systems and methods are disclosed herein. For example, in one embodiment an estimation system is disclosed, with such system comprising one or more communication devices that receive a property identifier from a user device, one or more storage devices that store a plurality of accounts, wherein a subset of the plurality of accounts are estimator accounts, and one or more processors.

The processors identify a plurality of potential estimators using the plurality of accounts, determine whether one or more of the plurality of potential estimators meet one or more predefined criteria, and transmit an estimate request to the of the plurality of potential estimators that meet the predefined criteria. The estimate request includes the property identifier and requesting an estimate of a property identified by the property identifier. The processors also generate an aggregate estimate from one or more estimates received from the of the plurality of potential estimators that meet the predefined criteria. The aggregate estimate is transmitted to the user device via the communication devices.

The predefined criteria may include a location associated with the accounts of the plurality of potential estimators that is within a predefined are around the property identified by the property identifier. In addition or alternatively, the predefined criteria may include a current location of the plurality of potential estimators that is within a predefined area around the property identified by the property identifier. The current location may be determined by a location detection device of the plurality of potential estimators.

The estimation system may wait a predefined period of time before generating the aggregate estimate. In addition or alternatively, the aggregate estimate may be generated once a predefined number of estimates are received from the of the plurality of potential estimators that meet the predefined criteria.

The estimates received from the of the plurality of potential estimators that meet the predefined criteria may be stored on the storage devices. Also, the processors may transmit a message indicating that no estimators are available if no potential estimators meet the predefined criteria.

In another embodiment, a method for generating an aggregate estimate for a property with an estimation system is disclosed, with such method comprising storing a plurality of estimator accounts on one or more storage devices of the estimation system, each of the plurality of estimator accounts including location information, receiving a property identifier identifying a property from a user device via one or more communication devices, and determining if one or more of the plurality of estimator accounts meet one or more predefined criteria by determining if the location information of the plurality of estimator accounts is within a predefined area around the property.

The method also includes transmitting an estimate request to the of the plurality of estimator accounts that meet the predefined criteria via the communication devices, generating an aggregate estimate from one or more estimates received from the of the plurality of estimator accounts that meet the predefined criteria, and transmitting the aggregate estimate to the user device.

The estimation system may wait a predefined period of time before generating the aggregate estimate. Alternatively, the aggregate estimate may be generated once a predefined number of estimates are received from the of the plurality of potential estimators that meet the predefined criteria.

The estimates received from the of the plurality of potential estimators that meet the predefined criteria may be stored on the storage devices. A message indicating that no estimators are available if none of the plurality of estimator accounts meet the predefined criteria may be transmitted to the user as well. The location information may comprise a business address, a current location determined by a location detecting device, or both.

In another exemplary embodiment, a non-transitory storage medium is disclosed, with such non-transitory storage medium storing instructions that, when executed, cause one or more processors to select one or more estimators from a plurality of estimator accounts based on one or more predefined criteria, transmit an estimate request to the selected estimators via one or more communication devices, the estimate request requesting an estimate for a property, receive one or more estimates from the selected estimators, generate an aggregate estimate from the estimates, and transmit the aggregate estimate to a user device.

The predefined criteria may include a location associated with the estimator accounts that is within a predefined are around the property. In addition or alternatively, the predefined criteria include a current location of the estimators that is within a predefined area around the property. The current location may be determined by a location detection device of the plurality of potential estimators.

The processor may wait a predefined period of time before generating the aggregate estimate. Alternatively, the aggregate estimate may be generated once a predefined number of estimates are received from the of the plurality of potential estimators that meet the predefined criteria. A message indicating that no estimators are available may be transmitted if none of the plurality of estimator accounts meet the predefined criteria.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a flow diagram illustrating operation of an exemplary crowd sourced estimation system;

FIG. 2 is a block diagram illustrating an exemplary crowd sourced estimation system;

FIG. 3 illustrates an exemplary estimator device and user interface therefor;

FIG. 4 illustrate an exemplary user device and user interface therefor; and

FIG. 5 is a block diagram illustrating an exemplary estimation server.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The crowd sourced estimation system provides estimates regarding the value of a particular property. Typically, and as disclosed herein, the crowd sourced estimation system will be arranged to provide estimates for real property, though it will be understood that the crowd sourced estimation system may be used for other types of property. As will be detailed further below, the crowd sourced estimation system requests estimate information (i.e., a value estimate) for a particular property from one or more estimators. The estimators will typically be selected based on particular criteria.

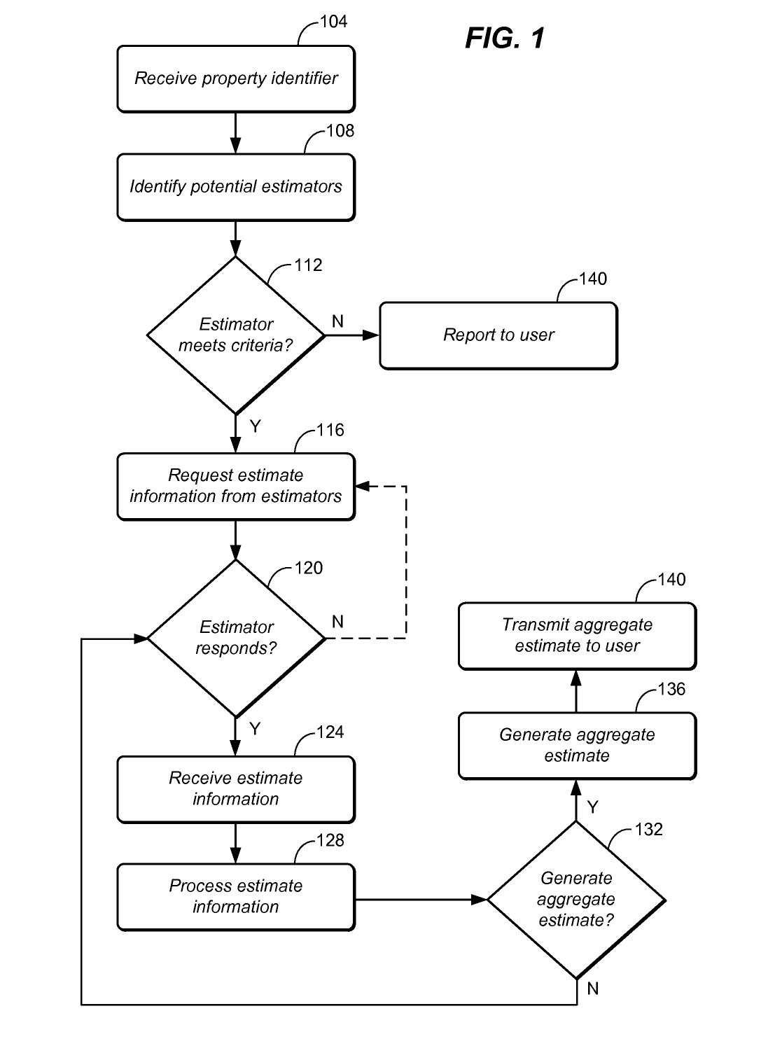

FIG. 1 is a flow diagram illustrating operation of an exemplary crowd sourced estimation system. As will be detailed further below, the crowd sourced estimation system will typically comprise hardware components, user and estimator client devices and one or more servers to provide the functionality disclosed herein. These devices may execute machine readable code fixed on a non-transient tangible medium to provide the functionality herein.

At a step 104, a property identifier may be received by the crowd sourced estimation system. A property identifier may be an address or other information that identifies a particular property for which an estimate is desired. A property identifier may be transmitted to the crowd sourced estimation system by various users. For example, such user may be the property owner or a third party interested in the value of the property.

At a step 108, potential estimators may be identified by the crowd sourced estimation system. For example, the crowd sourced estimation system may store a plurality of accounts authorized to access the crowd sourced estimation system. In such case, potential estimators may be all such individuals. Alternatively or in addition, estimators may be identified by their account type or other credentials. This is advantageous in that the crowd sourced estimation system may identify estimators as opposed to ordinary users of its services based on the account type or other credentials.

At a decision step 112, it may be determined if the potential estimators meet particular criteria. For example, in the case of a real property estimate, it may be desirable for estimators to be those familiar with the neighborhood or at least general area of the property to be estimated. In such circumstance, the crowd sourced estimation system may deem location criteria as met if a potential estimator is located, or has his/her place of business/address, within a predefined area around the property. It is contemplated that various other criteria may be used as well. For example, an estimator's identified expertise in commercial or residential properties may be used as criteria depending on whether the property is a residential or commercial property.

If no potential estimators meet predefined criteria at decision step 112, the same may be reported to the user at a step 140. To illustrate, a message may be sent to this user indicating that there are no estimators that meet the criteria to provide an estimate. It is contemplated that in some embodiments, the criteria may be relaxed (such as by expanding the predefined area around a property) or eliminated to allow at least one estimator to provide an estimate for the user.

If one or more estimators meet predefined criteria at decision step 112, a request for an estimate may be sent to each of such estimators at a step 116. Such request may indicate a request for an estimate is desired and provide a property identifier that identifies the property for which the estimate is desired. In addition, it is contemplated that one or more details or specifications describing the property may be provided as well. An estimator may utilize this information (e.g., square footage, number of bedrooms/baths, garages, pools, etc. . . . ) to generate his or her estimate.

At a decision step 120, if any estimator responds with their estimate, their estimate information may be received at a step 124 for processing at a step 128. Processing may include various activity. For example, in one embodiment, an estimate may be stored in a data storage device at step 128. It is contemplated that an estimate may be verified or checked at step 128 as well. For example, an estimate may be compared with other received estimates to determine if it is anomalous or an outlier. Alternatively, an estimate may be compared with a externally obtained baseline value to determine if it is anomalous or an outlier.

At a decision step 132, it may be determined whether an aggregate estimate is to be generated. This may occur in various ways. In one embodiment for example, an aggregate estimate is to be generated when a predefined number of estimates from the estimators (typically separate individual estimators) are received. For instance, in one exemplary embodiment, an aggregate estimate is to be generated when at least five estimates are received. Alternatively or in addition, an aggregate estimate may be generated after a predefined period of time has elapsed after estimate information was requested from estimators (or after another predefined event).

If an aggregate estimate is not to be generated, the process may return to decision step 120 to await estimates from estimators. If an aggregate estimate is to be generate, the same may occur at a step 136. Generation of an aggregate estimate may occur by aggregating or combining the received estimates. For example, the aggregate estimate may be an average or mean of the received estimates. It is noted that outliers or otherwise anomalous estimates, as may be identified at step 128, may be excluded from an aggregate estimate in one or more embodiments.

Once an aggregate estimate is generated at step 128, it may be sent to the user at a step 140. The aggregate estimate may be accompanied by other information as well. For example, identifying information for the estimators whose estimates were used in generating the aggregate estimate may be transmitted. Some exemplary identifying information includes, names, business names, contact information, photos, etc. The individual estimates used in generating the aggregate estimate may also be transmitted to the user along with the aggregate estimate. This supplemental information may be used by the user to contact one or more of the estimators for further information or to request their services. For instance, the user may request that one of the estimators assist in selling or buying the property for which the aggregate estimate was generated.

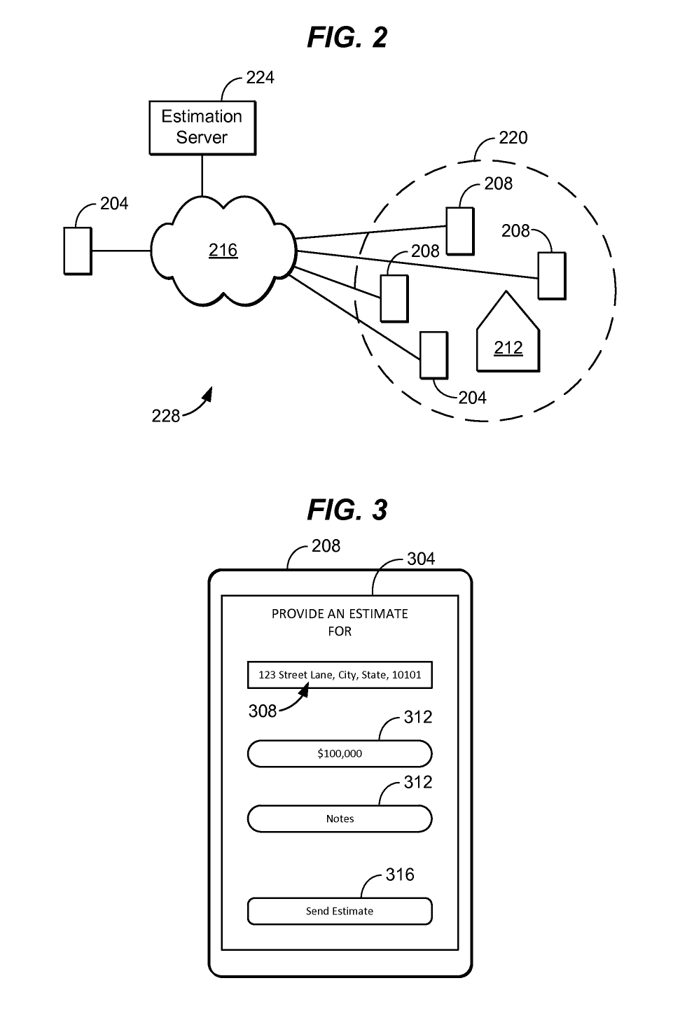

FIG. 2 is a block diagram illustrating an exemplary crowd sourced estimation system 228. As can be seen, a crowd sourced estimation system 228 may comprise one or more estimation servers 224, one or more user devices 204 and one or more estimator devices 208. Some exemplary user and estimator devices 204, 208 include desktop or laptop computer, tablet or smartphone or other mobile device. In one or more embodiments, at least the estimator devices 208 will require a location detection device, such as a GPS receiver, to permit discovery of an estimator's location.

An estimation server 224, user device 204 and estimator device 208 may communicate with one another via one or more wired or wireless communication links. A communication link may be wired or wireless and utilize various communication protocols. In addition, communication may be effectuated through one or more networks 216, such as the Internet, various wide area or local area networks, or various combinations thereof.

As disclosed above, a user device 204 may be used to request as well as subsequently view an aggregate estimate for a particular property 212. As can be seen, a user device 204 may be adjacent the property 212 or remote therefrom when such request is made. An estimator device 208 may be used to receive estimate requests and transmit estimator estimates once they are finalized. An estimator device 208 may also be used to view information about the property, such as its identifier and details or specifications thereof. It is contemplated that an estimator device may also be used to search for property details and specifications or other information useful in providing an accurate estimate.

As set forth above, location of an estimator may be a criteria to determine whether an estimate should be requested from such estimator. As can be seen from FIG. 2, a predefined area 220 around the property 212 defines which estimator devices 208 will receive a request. Estimator devices 208 outside the predefined area 220 may not be sent requests, as described above. It is noted that the location of an estimator may be defined by a location reported by the estimator rather than a current GPS location. For example, an estimator's location may be defined as his or her business, residence or other address.

FIG. 3 illustrates an exemplary estimator device 208 and an exemplary user interface screen presented by its display device 304. As can be seen, at least a property identifier 308 may be provided along with one or more input fields 312 to receive an estimator's estimate. It is contemplated that separate input fields 312 may be used to collect additional notes or questions an estimator wishes to input for sharing with a user. One or more buttons 316 may be provided as well such as to transmit an inputted estimate or other action when engaged.

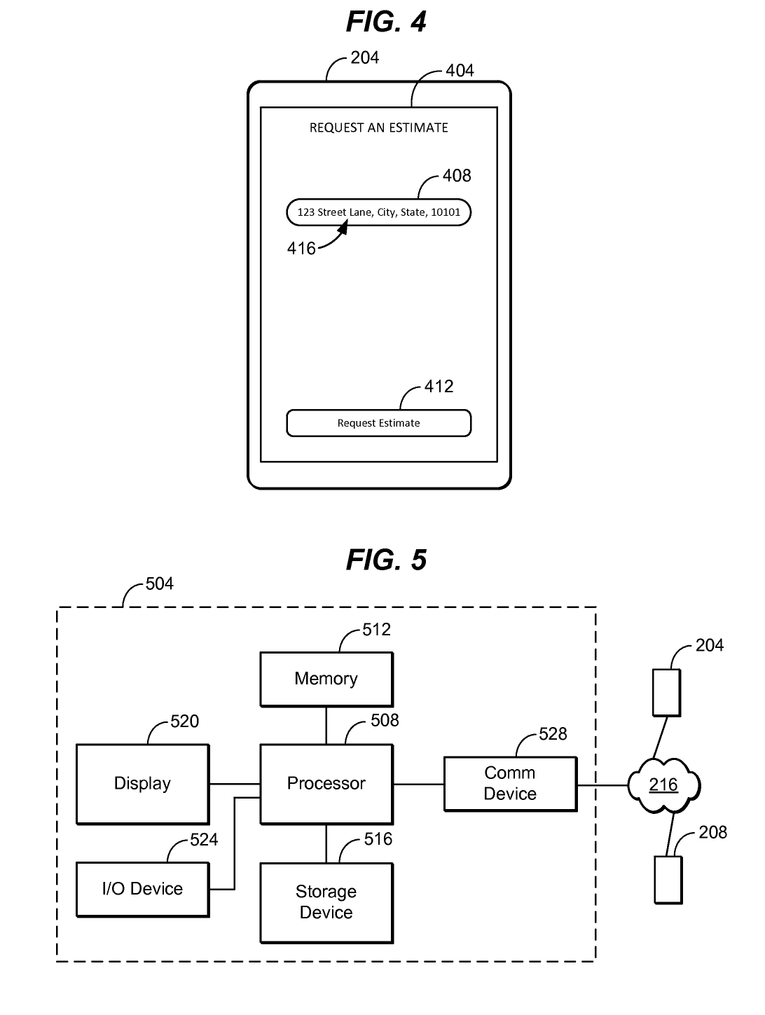

FIG. 4 illustrates an exemplary user device 204 and an exemplary user interface screen presented by its display device 404. As can be seen, one or more input fields 408 may be provided to receive input identifying a property, such as the property identifier 416 shown in FIG. 4. In addition, one or more buttons 412 may be provided to send the property identifier to an estimation server 224 to request an estimate. A user identifier may be transmitted along with the property identifier to indicate which user is making the request.

The exemplary estimator and user devices 208, 204 shown in FIGS. 3 and 4, respectively, are mobile devices, namely, smartphone or tablet devices with network communication capability and arranged to execute machine readable code to provide the functionality associated with these devices as disclosed herein. Each of these devices also includes one or more processors and storage devices to provide such functionality. As stated above, a location detection device may also be included.

As will now be described with regard to FIG. 5, an estimation server 504 may, among other things, coordinate communication and generate aggregate estimates for the crowd sourced estimation system. As can be seen, an estimation server may comprise one or more processors 508 and memory devices 512. In operation, a processor may execute machine readable code to provide the functionality of the estimation system disclosed herein. Machine readable code may comprise one or more instructions stored on a storage device 516 or hard wired into a processor 508. A memory device 512 may be used for temporary storage of values, machine readable code, and other data. Some exemplary memory devices include RAM, processor cache memory, and ROM. A memory device 512 may be integral to a processor 508 in one or more embodiments. Some exemplary storage technologies usable by a storage device include magnetic, optical, EPROM, or flash based storage.

One or more input/output devices 524 may be provided as well such as to allow various peripherals to be attached. Some exemplary peripherals include human interface devices, such as mice, keyboards, touchscreen, speakers, etc. One or more displays may be provided as well to present output screens. A display and one or more input/output devices 524 may be used to configure or setup the estimation system as well as to control its operation. In one or more embodiments, estimator criteria may be set and changed via an input/output device 524 for example. It is contemplated that such setting may also be changed remotely, such as through one or more communication devices 528.

One or more communication devices 528 will typically be provided to communicate with external devices, such as a user device 204 or estimator device 208. A communication device 528 may communicate via a wired or wireless communication link and using various communication protocols. In addition, a communication device 528 may communicate through one or more networks 216.

In operation, a communication device 528 may be directed by a processor 508 to receive property identifiers from user devices 204 and transmit estimate requests to estimator devices 208. Also, a communication device 528 may receive and transmit location information, property details and other data from and to, respectively, one or more user or estimator devices 204, 208, such as disclosed above.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An estimation system comprising:
one or more communication devices that receive a property identifier from a user device;
one or more storage devices that store a plurality of accounts, wherein a subset of the plurality of accounts are estimator accounts;
one or more processors that:
identify a plurality of potential estimators using the plurality of accounts;
determine whether one or more of the plurality of potential estimators meet one or more predefined criteria;
transmit an estimate request to the one or more of the plurality of potential estimators that meet the one or more predefined criteria, the estimate request including the property identifier and requesting an estimate of a property identified by the property identifier; and
generate an aggregate estimate from one or more estimates received from the one or more of the plurality of potential estimators that meet the one or more predefined criteria;
wherein the aggregate estimate is transmitted to the user device via the one or more communication devices.

2. The estimation system of claim 1, wherein the one or more predefined criteria include a location associated with the accounts of the plurality of potential estimators that is within a predefined are around the property identified by the property identifier.

3. The estimation system of claim 1, wherein the one or more predefined criteria include a current location of the plurality of potential estimators that is within a predefined area around the property identified by the property identifier, the current location as determined by a location detection device of the plurality of potential estimators.

4. The estimation system of claim 1 further comprising waiting a predefined period of time before generating the aggregate estimate.

5. The estimation system of claim 1, wherein the aggregate estimate is generated once a predefined number of estimates are received from the one or more of the plurality of potential estimators that meet the one or more predefined criteria.

6. The estimation system of claim 1, wherein the one or more estimates received from the one or more of the plurality of potential estimators that meet the one or more predefined criteria are stored on the one or more storage devices.

7. The estimation system of claim 1, wherein the one or more processors transmit a message indicating that no estimators are available if no potential estimators meet the one or more predefined criteria.

8. A method for generating an aggregate estimate for a property with an estimation system comprising:
storing a plurality of estimator accounts on one or more storage devices of the estimation system, each of the plurality of estimator accounts including location information;
receiving a property identifier identifying a property from a user device via one or more communication devices;
determining if one or more of the plurality of estimator accounts meet one or more predefined criteria by determining if the location information of the plurality of estimator accounts is within a predefined area around the property;
transmitting an estimate request to the one or more of the plurality of estimator accounts that meet the one or more predefined criteria via the one or more communication devices;
generating an aggregate estimate from one or more estimates received from the one or more of the plurality of estimator accounts that meet the one or more predefined criteria; and
transmitting the aggregate estimate to the user device.

9. The estimation system of claim 8 further comprising waiting a predefined period of time before generating the aggregate estimate.

10. The estimation system of claim 8, wherein the aggregate estimate is generated once a predefined number of estimates are received from the one or more of the plurality of potential estimators that meet the one or more predefined criteria.

11. The estimation system of claim 8 further comprising storing the one or more estimates received from the one or more of the plurality of potential estimators that meet the one or more predefined criteria on the one or more storage devices.

12. The estimation system of claim 8 further comprising transmitting a message indicating that no estimators are available if none of the plurality of estimator accounts meet the one or more predefined criteria.

13. The estimation system of claim 8, wherein the location information comprises a business address.

14. The estimation system of claim 8, wherein the location information comprises a current location determined by a location detecting device.

15. A non-transitory storage medium storing instructions that, when executed, cause one or more processors to:
select one or more estimators from a plurality of estimator accounts based on one or more predefined criteria;
transmit an estimate request to the one or more selected estimators via one or more communication devices, the estimate request requesting an estimate for a property;
receive one or more estimates from the one or more selected estimators;
generate an aggregate estimate from the one or more estimates;
transmit the aggregate estimate to a user device.

16. The non-transitory storage medium of claim 15, wherein the one or more predefined criteria include a location associated with the one or more estimator accounts that is within a predefined are around the property.

17. The non-transitory storage medium of claim 15, wherein the one or more predefined criteria include a current location of the one or more estimators that is within a predefined area around the property, the current location as determined by a location detection device of the plurality of potential estimators.

18. The non-transitory storage medium of claim 15 further comprising waiting a predefined period of time before generating the aggregate estimate.

19. The non-transitory storage medium of claim 15, wherein the aggregate estimate is generated once a predefined number of estimates are received from the one or more of the plurality of potential estimators that meet the one or more predefined criteria.

20. The non-transitory storage medium of claim 15 further comprising transmitting a message indicating that no estimators are available if none of the plurality of estimator accounts meet the one or more predefined criteria.
